(19) United States
(12) Patent Application Publication
(10) Pub. No.: US 2005/0268799 A1
(43) Pub. Date: Dec. 8, 2005

(54) Solder paste lateral flow and redistribution system and methods of same

(75) Inventors: Gerald C. Pham-Van-Diep, Hopkinton, MA (US); David P. Prince, Wakefield, RI (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Speedline Technologies, Inc., Franklin, MA (US)

(21) Appl. No.: 10/858,885

(22) Filed: Jun. 2, 2004

(51) Int. Cl. B41L 13/18

(52) U.S. Cl. 101/123

(57) ABSTRACT

An apparatus and methods for depositing material on a surface of an electronic substrate are provided and include a squeegee device or system for distributing material to be deposited on the electronic substrate. The squeegee device or system can include a first wiping blade and a second wiping blade spaced from and parallel to the first wiping blade. The first wiping blade and the second wiping blade are disposed at an angle relative to a vertical axis, the vertical axis being perpendicular to a surface of an electronic substrate, such that when the first and the second wiping blades contact a surface of a stencil to deposit or print the material onto the electronic substrate, the first and the second wiping blades contact the stencil surface at a rake angle relative to a direction in which the squeegee device traverses the stencil surface. The rake angle of the first and the second wiping blades enables the squeegee device to traverse the stencil surface at an angle, which causes the material deposited in front of either wiping blade to flow laterally in one direction toward an end of the wiping blade during a print stroke. In addition, the first wiping blade is offset relative to the second wiping blade such that as the material laterally flows in front of one of the wiping blades and runs off the end of the wiping blade during a print stroke, the other wiping blade is positioned to retrieve the material runoff and to thereby remix or redistribute the material runoff across the stencil surface during a print stroke in an opposite direction.

### FIELD OF THE INVENTION

The invention relates to apparatus and methods for screen printing, and more specifically to apparatus and methods for the screen printing of electronic substrates such as circuit board assemblies.

### BACKGROUND OF THE INVENTION

Manufacturing circuit boards involves a number of processes, one of which is the screen or stencil printing of solder paste and adhesives onto printed circuit boards in order to deposit electronic components onto the boards. A stencil having an aperture or, more typically, a plurality of apertures defines a pattern that corresponds to a pattern of pads or, usually conductive, surface areas disposed on or defined in a surface of a circuit board to which electronic components are mounted. The stencil is used to apply solder paste, adhesive or other materials to the pads or conductive surface areas such that surface mount electronic components can be disposed on and thereafter adhered to the surface of the circuit board. The stencil is typically positioned in a substantially parallel orientation to a surface of a board to be printed and the apertures are aligned with a desired pattern on the board surface. The solder paste, adhesive or other material to be deposited is then placed on top of the stencil for deposition into the aperture or apertures and onto the board. In many processes, a squeegee device can be used to traverse the top of the stencil to thereby spread or distribute the deposited material across the stencil to each of the apertures. Once the apertures are filled with material, the squeegee device can remove excess material from the top of the stencil to help to insure at least a portion of the deposited material remains within the aperture or apertures. The stencil is then separated from the board and the surface tension between the board and the deposited material causes most of the material to remain on the board surface.

Current squeegee devices or systems used in stencil or screen printing are configured to contact and traverse a surface of a stencil, as described above, whereby such action wipes the stencil surface to distribute solder paste or other material to the apertures. Such squeegee devices typically include one or more wiping blades that are placed in contact with the stencil surface where the line of contact between the blade and the stencil is substantially perpendicular to a direction of the squeegee print stroke. The print stroke is typically movement in a linear direction along an X-axis of motion or a Y-axis of motion across the stencil. When such a squeegee device wipes the stencil surface in a linear print stroke, solder paste or other material disposed in front of a wiping blade tends to flow laterally toward each and of the blade as the blade moves forward in a linear direction, producing a flow of excess solder paste or solder paste runoff from the ends of the blade. Solder paste runoff tends to migrate from the blade ends toward the edges of the stencil, as well as other areas of the stencil surface that the wiping blade cannot reach. As the wiping blade typically cannot reach the stencil edges, solder paste runoff tends to go to waste unless an operator regularly mixes the runoff disposed along the stencil edges, or other hard-to reach-areas of the stencil, with bulk paste used in the stenciling process or with material remaining on the stencil. Without remixing or redistributing solder paste runoff, the theology of the paste changes rapidly and, as a result, cannot be remixed or used. In addition, during the printing process, solder paste tends to compact along regions of the stencil having a high density of fine apertures. Without an ability to remix or redistribute solder paste disposed along such regions, current squeegee devices are incapable of delaying or preventing local solder paste compaction on stencil surfaces.

### SUMMARY OF THE INVENTION

In a first aspect of the invention, an apparatus for performing operations on a surface of an electronic substrate comprises a frame, a substrate support, coupled to the frame, to support the electronic substrate, a stencil coupled to the frame having at least one aperture to receive a material to be deposited through the aperture onto the surface of the electronic substrate, and a squeegee device coupled to the apparatus and configured to contact a surface of the stencil and to traverse the stencil surface in at least a first direction to distribute the material deposited thereon to the at least one aperture. The squeegee device includes a first wiping blade disposed at a rake angle relative to a vertical axis, the vertical axis being perpendicular to the surface of the stencil. The arrangement is such that when the squeegee device contacts the stencil surface, a line of contact between the first wiping blade and the stencil surface is angled relative to at least the first direction in which the squeegee device traverses the stencil surface.

In a second aspect of the invention, the rake angle of the first wiping blade is an angle sufficient to cause the material to flow laterally in one direction from one end to another opposite end of the first wiping blade when the first wiping blade traverses the stencil surface and pushes the material deposited thereon across the stencil surface. The squeegee device further comprises a second wiping blade spaced from and parallel to the first wiping blade, the second wiping blade being disposed at a rake angle relative to a vertical axis, the vertical axis being perpendicular to the surface of the stencil. The arrangement is such that when the squeegee device contacts the stencil surface, a line of contact between the second wiping blade and the stencil surface is angled relative to at least the first direction of the squeegee device.

The rake angle of the second wiping blade is an angle sufficient to cause the material to flow laterally in one direction from one end to another opposite end of the second wiping blade when the second wiping blade traverses the stencil surface and pushes the material deposited thereon across the stencil surface.

The first wiping blade and the second wiping blade are further disposed such that the second wiping blade is offset relative to the first wiping blade. The second wiping blade is positioned relative to the first wiping blade to capture runoff of the material flowing laterally from the first wiping blade as the squeegee device traverses the stencil surface in the first direction. The first wiping blade is positioned relative to the second wiping blade to capture runoff of the material flowing laterally from the second wiping blade as the squeegee device traverses the stencil surface in a second direction opposite to the first direction. The apparatus may further comprise a material dispenser configured and disposed to deposit a volume of the material on the surface of the stencil, and a controller operatively coupled to the squeegee device to control a position of and a direction in which the squeegee device traverses the stencil. The controller is configured to control independently a position of each of the first and the second wiping blades such that the controller raises each of the first and the second wiping blades from the stencil surface and lowers each of the first and the second wiping blades to contact the stencil surface.

In a third aspect of the invention, a method of dispensing material on a surface of an electronic substrate comprises: (a) loading an electronic substrate into a printing apparatus; (b) supporting the substrate with a substrate support during dispensing; (c) aligning a stencil above a surface of the electronic substrate, the stencil having at least one aperture through which material is deposited onto the surface of the electronic substrate; (d) determining a rake angle of a first wiping blade of a squeegee device coupled to the printing apparatus, the squeegee device being configured to contact a surface of the stencil and to distribute the material deposited thereon across the stencil surface to the at least one aperture; and (e) traversing the squeegee device across the stencil surface in at least the first direction.

In a fourth aspect of the invention, the rake angle of the first wiping blade is an angle sufficient to cause the material to flow laterally in one direction from one end to another opposite end of the first wiping blade when the squeegee device traverses the stencil surface and pushes the material deposited thereon across the stencil surface. The rake angle of a second wiping blade of the squeegee device is spaced from and disposed parallel to the first wiping blade, the rake angle of the second wiping blade being an angle relative to a vertical axis, the vertical axis being perpendicular to the stencil surface. The arrangement is such that when the squeegee device contacts the stencil surface, a line of contact between the second wiping blade and the stencil surface is angled relative to at least the first direction in which the squeegee device traverses the stencil surface. The rake angle of the second wiping blade is an angle sufficient to cause the material to flow laterally in one direction from one end to another opposite end of the second wiping blade when the squeegee device traverses the stencil surface and pushes the material deposited thereon across the stencil surface.

The method further includes offsetting the second wiping blade relative to the first wiping blade such that the second wiping blade is positioned relative to the first wiping blade to capture runoff of the material flowing laterally from the first wiping blade as the squeegee device traverses the stencil surface in the first direction. The first wiping blade is positioned relative to the second wiping blade to capture runoff of the material flowing laterally from the second wiping blade as the squeegee device traverses the stencil surface in a second direction opposite to the first direction.

Various aspects of the invention may provide one or more of the following advantages. Solder pastes, adhesives or other materials can be used effectively in stencil printing electronic substrates, such as circuit board assemblies, by minimizing or eliminating material waste or runoff produced during stenciling processes. For instance, solder paste waste or runoff, e.g., solder paste migrating toward edges of a stencil and other hard-to-reach areas of a stencil during a stenciling process, can be remixed with bulk solder paste used in the process and/or can be redistributed across the stencil to help to eliminate or reduce the amount of solder paste waste. Remixing excess solder paste during a stencil process helps to maintain a desired theology of solder paste employed and to thereby enable excess or runoff solder paste to be reused during stenciling. Redistributing excess or runoff solder paste during a stencil process helps to reduce or to eliminate local compaction of excess or runoff solder paste in areas of a stencil defining a high density of fine apertures. Remixing and redistributing excess or runoff solder paste enables all or substantially all of the apertures defined in a surface of a stencil receive solder paste to deposit there through to a surface of an electronic substrate.

These and other advantages of the invention, along with the invention itself, will be more fully understood after a review of the following figures, detailed description, and claims.

### BRIEF DESCRIPTION OF THE FIGURES

FIG. 1 is a perspective view of a printing apparatus in accordance with one embodiment of the invention;

FIG. 2 is a perspective view of a prior art squeegee device or system;

FIG. 3 is a top view schematic of a blade of the prior art squeegee device or system shown in FIG. 2;

FIG. 4 is a top view schematic of a two-blade squeegee device in accordance with one embodiment of the invention;

FIG. 5 is a top view schematic of the two-blade squeegee device shown in FIG. 4; and

FIG. 6 is a flow diagram of a method of distributing material across a substrate.

### DETAILED DESCRIPTION OF PREFERRED EMBODIMENTS

Embodiments of the present invention are described below with reference to screen printers or stencil printers that print solder paste, adhesive or other materials onto circuit boards. As understood by those of ordinary skill in the art, embodiments of the present invention can be used with electronic substrates other than circuit boards and with machines other than screen printers.

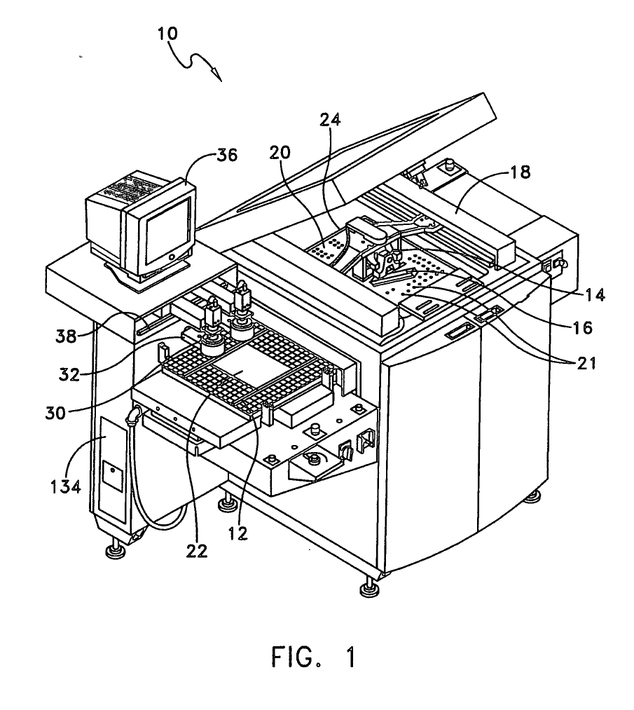

Referring to FIG. 1, a printer 10 in accordance with one embodiment of the invention that applies solder pastes, adhesives or other materials to substrates, such as circuit boards, is shown. The printer is an improvement over the screen printer described in U.S. Pat. No. 5,794,329, U.S. Pat. No. 6,324,973 and U.S. patent application Ser. No. 10/236,108, each of which is hereby incorporated by reference.

As shown in FIG. 1, the printer 10 includes a tractor feed mechanism 12 coupled to a printer frame to support and to transfer a substrate, e.g., a circuit board 22, a material dispenser 14, a squeegee device 16, a frame support 18 to support the dispenser and the squeegee device, a stencil 20 coupled to the printer frame, and a support surface 24 to help to support the stencil above the tractor feed mechanism 12. Optionally, the printer 10, as shown, can further include one or more cameras 30 carried on a carriage 32, a controller 34 and a monitor 36. The cameras 30 disposed on and carried by the carriage 32 are moveable along tracks 38 so that the cameras 14 may move in a linear X-axis of motion. The carriage also enables the cameras 30 to move in a linear Y-axis of motion. The stencil 20 is attached to the printer frame such that it is positioned above a circuit board 22 disposed on the tractor feed mechanism 12. The circuit board 22 enters the printer 10 on the tractor feed mechanism 12 for printing. As shown, the material dispenser 14 and the squeegee device 16 are attached to the printer 10 in a position above a level of the stencil 20.

The stencil 20 defines a plurality of apertures 21, which are distributed in a certain pattern across the stencil 20 that corresponds to a pattern of pads or other, usually conductive, surface areas already defined in or disposed on a surface of the circuit board 22. The apertures 21 are configured and sized to permit solder paste, adhesive or other material to be disposed there through to the surface of the circuit board 22.

As noted, circuit boards 22 fed into the printer 10 typically have a pattern of pads or conductive surface areas onto which material, e.g., solder paste, will be deposited. In one embodiment, when directed by the controller 34 of the printer 10, the tractor feed mechanism 12 supplies circuit boards 22 to a location where the camera 14 records an image of the board 22. The image is sent to the controller 34, which signals to shuttle the board 22 to a second location over the board support surface 24 disposed within the printer 10 under the stencil 20. Once arriving at a position under the stencil 20, the circuit board 22 is in place for a manufacturing operation. To successfully deposit solder paste on the circuit board 22, the controller 34 positions the board 22 such that the board 22 and the stencil 50 are aligned, e.g., at least a portion of the apertures 21 of the stencil 20 are aligned with at least a portion of the pads or other surface areas of the board 22 to receive material. Preferably, the apertures 21 are completely aligned with the pads of the circuit board 22. When the stencil 50 and the circuit board 22 are aligned correctly, the stencil 20 is lowered toward the board 22 for application of solder paste, adhesive or other material through the apertures 21, or, alternatively, the board 22 can be raised upward toward the stencil 20 by the board support surface 24.

The material dispenser 14, positioned above the circuit board 22, can vary the amount of solder paste, adhesive or other material delivered to or dispensed on a surface of the stencil 20 and thereafter applied by the squeegee device 16. The squeegee device 16 is disposed and configured to traverse the stencil 20 and thereby push or distribute the deposited material, e.g., solder paste, into at least a portion of the stencil apertures 21, from which the solder paste will be released onto the board 22. After solder paste has been deposited on the circuit board 22 in the desired pattern, the board support moves downward away from the position of the board 22, or, alternatively, the stencil 20 moves upward away from the board 22, under control of the controller 34. The controller 34 then controls movement of the circuit board 22 to the next location using the tractor feed mechanism 12, e.g., where electrical components can be placed on the board 22 at positions where solder paste is deposited.

Those of ordinary skill in the art can appreciate that in other embodiments of the invention, stencil printing can proceed as described above without the use of the controller 34 and/or the cameras 30, and such steps can be fully or partially automated by other means known in the art.

As discussed, during the deposition of a material, e.g., solder paste, onto a surface of the circuit board 22, the stencil 20 is aligned such that at least a portion of the apertures 21 correspond in location, shape and/or size to certain areas on a surface of the board 22 onto which solder paste is to be deposited. When aligned, the material dispenser 14 releases solder paste onto a surface, e.g., the top surface, of the stencil 20 whereby the apertures 21 are filled. The squeegee device 16 performs the process of filling the apertures 21 by traversing or wiping the top surface of the stencil 20 to push deposited solder paste through each or at least a portion of the apertures 21 and onto the desired locations on the circuit board 22. Solder paste is released onto the surface of the board 22 when the stencil 20 is moved away from the board 22, or when the board 22 is moved downward and away from the stencil 20. During this phase, applying a substantially consistent amount of solder paste over areas of the board's surface where electronic components will be placed is desirable.

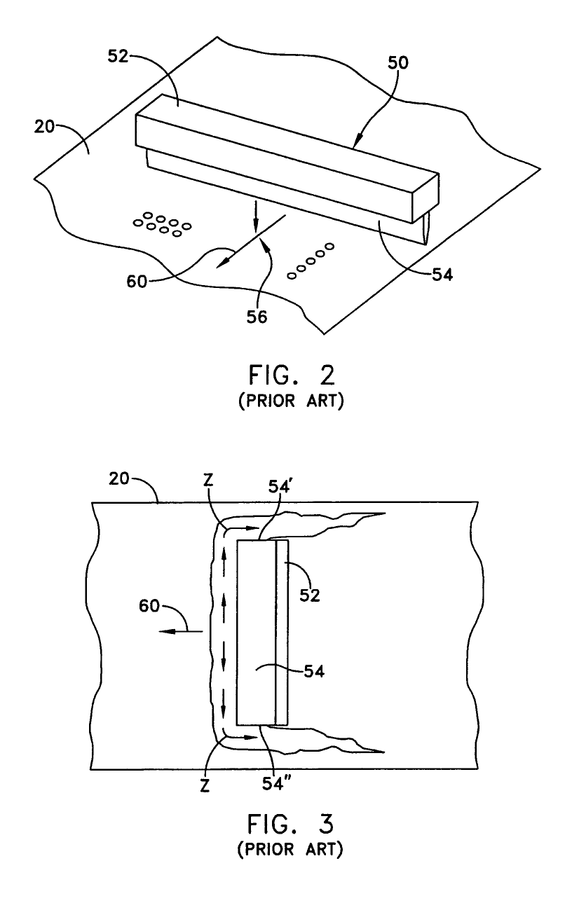

Referring to FIG. 2, a prior art squeegee device 50 is shown which includes one or more mounting members 52 configured to fasten to or connect with the printer 10, e.g., the frame support 18 and/or the material dispenser 14. Each mounting member 52 includes a blade 54. The blade 54 is typically joined or mounted to the member 52 such that the line of contact 56 between the blade and a surface of the stencil 20 is substantially perpendicular to a direction of the print stroke of the squeegee device 50, as shown by arrow 60 in FIG. 2.

Referring to FIG. 3, a top view schematic of a blade 54 of the squeegee device 50 shows a direction and the effects of the print stroke of the device. The print stroke is typically linear along either an X-axis of motion or a Y-axis of motion such that the blade 54 essentially pushes or wipes material, e.g., solder paste, deposited on the top surface of the stencil 20 in a linear direction across the stencil 20, as shown by arrow 60 in FIG. 3. During the print stroke, solder paste moves forward but also flows sideways toward each side edge 54′, 54″ of the blade 54, as shown by arrows Z in FIG. 3, as a result of the forward force of the device 50. Solder paste eventually migrates from the side edges of the blade 54 to one or more edges of the stencil 20. As a result, the prior art squeegee device 50 leaves substantial solder paste runoff in its wake during a print stroke that migrates toward edges of the stencil 20 as well as other areas of the stencil 20 that the blade 54 cannot reach. To be used in further stencil printing, such solder paste is retrieved and either remixed with bulk paste or redistributed across the stencil 20. Otherwise, the solder paste is discarded.

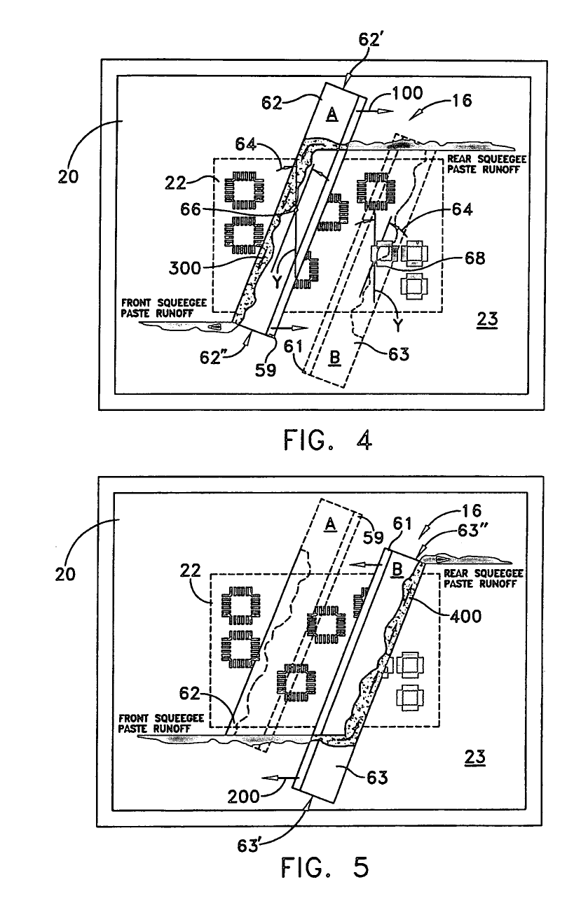

Referring to FIGS. 4 and 5, a schematic top view of the squeegee device 16 in accordance with one embodiment of the invention is shown for use alone or in combination with the printer 10 of FIG. 1. The squeegee device 16 is configured as a two-blade device and includes a first mounting member 59 and a second mounting member 61 fastened to or configured with the material dispenser 14, the support frame 18 of the dispenser 14, the printer frame and/or any other appropriate portion of the printer 10. The first and the second mounting members 59, 61 include a first and a second wiping blade 62, 63, respectively. The first member 59 and its wiping blade 62 are spaced from and parallel to the second member 61 and its wiping blade 63. In one embodiment, each wiping blade 62, 63 can be configured to removably fasten or mount to its respective member 59, 61.

As shown in FIGS. 4 and 5, each member 59, 61 is connected to or configured with the material dispenser 14, the support frame 18, the printer frame and/or any other appropriate portion of the printer 10 at an angle 64 such that the wiping blades 62, 63 are rotated in the same direction about spaced apart vertical axes 66, 68 wherein each vertical axis is perpendicular to a surface 23 of the stencil 20. Specifically, angle 64 represents the angel between (a) a normal axis Y (as depicted in FIG. 4) that is perpendicular to the vertical axis (66 or 68) and the axis of the print stroke, and (b) the axis defined by the body of the member (59 or 61) or of the blade (62 or 63). The normal axis Y is also parallel to the surface 23 of the stencil 20. When in contact with the surface 23 of the stencil 20, the line of contact between each blade 62, 63 and the stencil surface 23 is angled relative to a direction of the print stroke, as opposed to being perpendicular to the print stroke direction shown in FIGS. 2 and 3. As shown in the top views of FIGS. 4 and 5, the members 59, 61 or the blades 62, 63 essentially rake either left to right or right to left from their respective vertical axes such that the blades 62, 63 traverse the stencil surface 23 at an angle relative to the print stroke direction, such direction being depicted by arrows 100 and 200 in FIGS. 4 and 5, respectively.

In an alternative embodiment, each member 59, 61 can be connected to or configured with the material dispenser 14, the support frame 18, the printer frame and/or any other appropriate portion of the printer 10 in a substantially perpendicular orientation relative to the surface 23 of the stencil 20 and each blade 62, 63 can be attached to or mounted with its respective member 59, 61 at an angle. Each blade 62, 63 is rotated in the same direction about its respective vertical axis, wherein the vertical axes are perpendicular to the stencil surface 23. As a result, when the blades 62, 63 contact the stencil surface 23, the line of contact between each blade 62, 63 and the stencil surface 23 is, as described above, at an angle relative to a direction of the print stroke. The blades 62, 63 rake left to right or right to left from the vertical axes such that the blades 62, 63 traverse the stencil surface 23 at an angle.

In addition, each member 59, 61 is connected to the material dispenser 14, the support frame 18 or other portion of the printer 10 in such a manner the first member 59 is offset relative to the second member 61. As shown in FIGS. 4 and 5, the first member 59 and the first wiping blade 62 constitute a front squeegee A, while the second member 61 and the second wiping blade 63 constitute a rear squeegee B. The front and the rear squeegees A and B are parallel and offset relative to one another so that the rear squeegee is positioned slightly lower than the front squeegee in the manner depicted in FIGS. 4 and 5.

Further, each member 59, 61 is configured and connected to the material dispenser 14, the support frame 18 or other portion of the printer 10 such that the first squeegee A and the second squeegee B can operate either simultaneously or independently whereby one or both squeegees may be lowered to contact the stencil surface 23 during a print stroke. In one embodiment, the members 59, 61 can be operatively coupled to the controller 34 whereby the controller 34 automatically controls the positions of the front and the rear squeegees A and B during stencil printing. For instance, during a first print stroke, the controller 34 can cause the front squeegee A to be lowered to contact the stencil surface 23, while causing the rear squeegee B to remain raised above the stencil surface 23 and, during a second print stroke, cause the front squeegee B to be raised and the rear squeegee B to be lowered to contact the stencil surface 23. Such operation is illustrated in FIGS. 4 and 5 where the front squeegee A is in contact with the stencil surface 23 and the rear squeegee (shown in dashed lines in FIG. 4) is raised above the surface 23 when the squeegee device 16 traverses the stencil surface 23 in a first direction parallel to the direction of the print stroke, shown by arrows 100 in FIG. 4. When the squeegee device 16 traverses the surface 23 in a second, opposite direction, shown by arrows 200 in FIG. 5, the front squeegee A (shown in dashed lines in FIG. 5) is raised above the surface 23 and the rear squeegee B is lowered to contact the stencil surface 23. In other embodiments of the invention, the front and the rear squeegees A and B can be controlled to simultaneously contact the stencil surface 23 during a single print stroke as the device 16 traverses the surface 23 in either the first or the second direction 100, 200 as may be required to distribute material across the stencil 20.

As shown in FIGS. 4 and 5, when the squeegee device 16 traverses the stencil surface 23 in the first direction, shown by arrows 100, during a first print stroke, the first wiping blade 62 of the front squeegee A causes solder paste or other material deposited on the stencil surface 23 in front of the wiping blade 62 to flow laterally in one direction, shown by arrows 300 in FIG. 4, from a location at or near a first end 62′ to a second end 62″ of the wiping blade 62. As the front squeegee A continues to move across the stencil surface 23, solder paste migrates from the second end 62″ of the wiping blade 62 as front squeegee paste runoff. When the front squeegee A completes a full print stroke, the front squeegee A is raised from the stencil surface 23 and the rear squeegee B is lowered to the stencil surface 23 such that the second wiping blade 63 contacts the surface 23 and thereby traverses the surface 23 in an opposite direction, shown by arrows 200 in FIG. 5, during a second print stroke. Due to the offset orientation of the front and the rear squeegees A and B, the second wiping blade 63 captures the front squeegee paste runoff migrating from the second end 62″ of the first wiping blade 62 and pushes such paste runoff across the stencil surface 23. The second wiping blade 63 of the rear squeegee B similarly causes solder paste to flow laterally in one direction, as shown by arrows 400 in FIG. 5, from a location at or near a first end 63′ to a second end 63″ of the wiping blade 63. Solder paste migrates from the second end 63″ of the second wiping blade 63 as the rear squeegee B continues across the stencil surface 23 and constitutes rear squeegee paste runoff. In a similar manner, when the rear squeegee B completes a full print stroke, the rear squeegee B is raised from the stencil surface 23 and the front squeegee A can be lowered to the stencil surface 23 such that the front squeegee A may traverse the surface 23 in the first direction, as shown by arrows 100, and the first wiping blade 61 can capture the rear squeegee runoff from the second end 63″ of the second wiping blade 63. The front and the rear squeegees A and B can traverse the stencil surface 23 in the first and the second directions 100 and 200 as described and illustrated in FIGS. 4 and 5 for any desired number of print strokes to distribute solder paste to stencil apertures 21 and to remix/redistribute solder paste runoff.

Traversing the stencil surface 23 as described, the squeegee device 16 of the invention captures and redistributes solder paste runoff migrating from the second ends 62″, 63″ of the wiping blades 62, 63 such that excess solder paste is not permitted to migrate toward edges of the stencil 20, or other hard-to-reach areas of the stencil 20 the blades 62, 63 cannot reach, and is thereby wasted. Rather, the squeegee device 16 is configured and arranged to permit solder paste to remain on the stencil surface 23 within areas that the wiping blades 62, 63 can reach and enables the blades 62, 63 to redistribute and remix solder paste runoff. As a result, all or at least a substantial portion of a volume of solder paste deposited on the stencil surface 23 is distributed, e.g., repeatedly, across the stencil surface 23. In addition, the theology of the solder paste runoff remains effective due to the wiping blades 62, 63 remixing such paste during its redistribution across the stencil 20.

The rake angle of the first and second wiping blades 62, 63 and/or the rake angle of the first and second mounting members 59, 61, the distance between the front and the rear squeegees A and B, and/or the degree to which the front and the rear squeegees A and B are offset relative to one another can be affected by the type of material to be deposited, the physical properties, e.g., viscosity, of the material, a volume of the material deposited on the stencil surface 23, the configuration and/or dimensions of the stencil 20, the number, size and/or distribution of the stencil apertures 21, and/or the number and/or length of print strokes. In embodiments of the present invention, the rake angle of the first and the second wiping blades 62, 63 and/or the mounting members 59, 61 can be similarly adjusted, e.g., increased or decreased, for instance, by the controller 34 or by an operator to accommodate the type and volume of solder paste deposited on the stencil surface 23 for printing onto a circuit board 22. For example, for large volumes of solder paste, the rake angle may be sufficiently acute (e.g., between 0-45°) with respect to a vertical axis relative to the stencil surface 23 such that solder paste flows laterally in one direction in front of a wiping blade 62, 63 at a rapid rate. The alternate wiping blade 62, 63 can capture the solder paste runoff for redistribution across the stencil surface in an opposite direction. Producing a rapid rate of paste runoff would help to reduce or eliminate a volume of solder paste remaining in front of the wiping blade 62, 63 when the blade completes a full print stroke.

The squeegee device 16 is preferably constructed of a suitable material for use with units and assemblies, e.g., a stencil printer, used for printing or depositing materials onto a substrate, e.g., a circuit board or other electronic substrate. In particular, the wiping blades 62, 63 can be constructed of material suitable for wiping a surface of a stencil and for distributing or pushing a quantity of deposited material across the stencil surface. Suitable materials of the wiping blade 62, 63 include, but are not limited to, metal, rubber, plastic, polyurethane, TEFLON®-coated material and any combinations thereof.

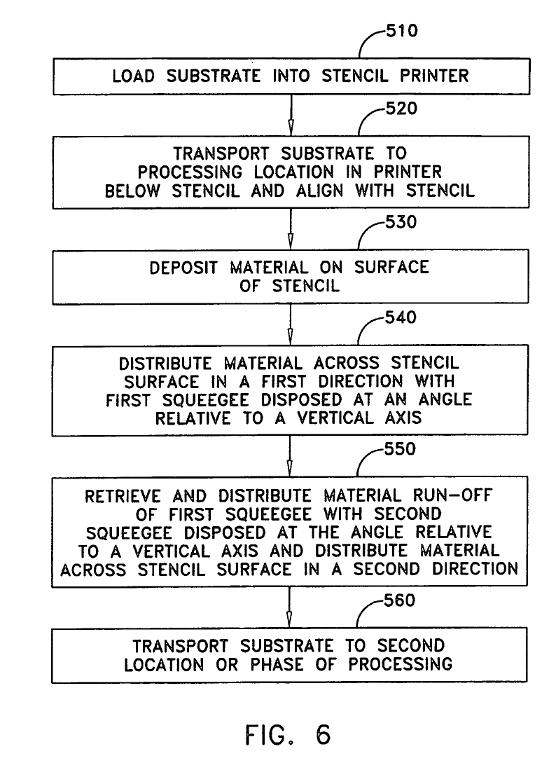

Referring to FIG. 6, a flow diagram illustrates a method 500 by which the squeegee device 16 of the invention operates. The method 500, however, is exemplary only and not limiting. The method 500 can be altered, e.g., by having stages added, removed or rearranged. In addition, the method 500 can be used to deposit different materials to other substrates than those described herein.

At stage 510, the substrate, e.g., circuit board 22, is loaded into the stencil printer 10.

At stage 520, the circuit board 22 is then transported to a manufacturing/processing location within the printer 10 and aligned below the stencil 20.

At stage 530, solder paste is deposited onto the surface 23 of the stencil 20, which has defined therein the plurality of apertures 21 distributed in a pattern that corresponds to a desired pattern of pads or other surface areas of the circuit board 22 to which surface mount electronic components are to be disposed and thereafter adhered to mechanically and/or electrically. In one embodiment, the material dispenser 14 is configured and disposed to deposit a volume of solder paste in front of one of the wiping blades 62, 63 or between the wiping blades 62, 63.

At stage 540, after deposition of the solder paste, the rake angle of the wiping blades 62, 63 and/or the rake angle of the first and the second mounting members 59, 61, the distance between the front and rear squeegees A and B and/or the degree to which the front and the rear squeegees A and B are offset with respect to one another can be adjusted relative to, for instance, the type and volume of material to be deposited by the controller 34 or a user. As discussed above, the rake angle of the wiping blades 62, 63 and the positions of the front and rear squeegees A and B can be adjusted with respect to any physical properties of the deposited material, the configuration or dimensions of the stencil 20, and/or the size, configuration and distribution of the stencil apertures 21. Such characteristics of the squeegee device 16 can be adjusted either by the controller 34 or by a user, so that the squeegee device 16 can distribute solder paste and can remix/redistribute solder paste runoff such that all or substantially all of the solder paste deposited on the stencil surface 23 fills the stencil apertures 21, e.g., little or no solder paste remains on the stencil surface 23 after the squeegee device 16 completes a desired number of print strokes across the stencil 20. Once the rake angle is adjusted, a first or the front squeegee A traverses the stencil surface 23 in one direction at an angle relative to a vertical axis 66 or 68 and distributes solder paste to apertures during a print stroke, causing solder paste deposited in front of the first wiping blade 62 to flow laterally in one direction from one end 62′ to another end 62″ of the wiping blade 62 and producing a solder paste runoff.

At stage 550, a second or the rear squeegee B retrieves the solder paste runoff of the first or the front squeegee A and traverses the stencil surface 23 in a second or opposite direction at an angle relative to a vertical axis 68 and distributes the solder paste runoff during a print stroke, similarly producing a solder paste runoff if a sufficient amount of solder paste remains on the stencil surface 23. Stages 540 and 550 can be repeated a desired number of times to remix and distribute solder paste and paste runoff to the stencil apertures 21.

At stage 560, the circuit board 22 is transported to a second processing location within the printer or to the next processing phase with the solder paste disposed on its surface.

In the embodiments of the present invention described above, the squeegee device 16 is a two-blade device having the first and the second wiping blades 62, 63 forming the front and the rear squeegees A and B wherein the front and the rear squeegees A and B are offset and parallel relative to one another and one of the front and the rear squeegees A and B is in contact with the stencil surface 23 during a print stroke in a first direction and the other squeegee is in contact with the stencil surface 23 during a print stroke in a second opposite direction. However, other embodiments are within the scope and spirit of the appended claims. As understood by those of ordinary skilled in the art, other configurations of the two-blade squeegee device 16 may include both the front and the rear squeegees being in contact with the stencil surface 23 during a print stroke in either or both first or second directions and during a desired number of print strokes to fill the stencil apertures 21. In addition, the two-blade squeegee device 16 can be incorporated with or configured with the material dispenser 14 to operate as a single unit whereby the dispenser 14 deposits a volume of material in front of one or both of the wiping blades 62, 63 during a stenciling process. Further, the squeegee device 16 of the invention is not limited to the wiping blades 62, 63 as depicted and described with reference to FIGS. 4 and 5 and can include other types of devices configured to distribute solder paste across the stencil surface 23.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

1. An apparatus for printing one of solder paste and adhesive on a surface of an electronic substrate, the apparatus comprising:
a frame;
a substrate support, coupled to the frame, to support the electronic substrate;
a stencil, coupled to the frame, having at least one aperture to receive a material one of solder paste and adhesive to be deposited through the aperture onto the surface of the electronic substrate;
a material dispenser coupled to the frame and positioned above the stencil, to dispense one of solder paste and adhesive on the stencil; and
a squeegee device configured to contact a surface of the stencil and to traverse the stencil surface in at least a first direction along a print axis to distribute the one of solder paste and adhesive deposited thereon to the at least one aperture, the squeegee device including a first wiping blade disposed at a rake angle relative to a normal axis, the normal axis being perpendicular to the print axis and parallel to the surface of the stencil.

2. The apparatus of claim 1, wherein the rake angle of the first wiping blade is an angle sufficient to cause the one of solder paste and adhesive to flow in a direction from a location at or near an end to an opposite end of the first wiping blade when the first wiping blade traverses the stencil surface and pushes the one of solder paste and adhesive deposited thereon across the stencil surface.

3. The apparatus of claim 2, wherein the rake angle is determined by a controller.

4. The apparatus of claim 1, wherein the squeegee device further comprises a second wiping blade spaced from and parallel to the first wiping blade.

5. The apparatus of claim 4, wherein a rake angle of the second wiping blade is an angle sufficient to cause the one of solder paste and adhesive to flow in a direction from a location at or near an end to an opposite end of the second wiping blade when the second wiping blade traverses the stencil surface and pushes the one of solder paste and adhesive deposited thereon across the stencil surface.

6. The apparatus of claim 5, wherein the rake angles of the first and second wiping blades are determined by a controller.

7. The apparatus of claim 5, wherein the first wiping blade and the second wiping blade are further disposed such that the second wiping blade is offset relative to the first wiping blade.

8. The apparatus of claim 7, wherein the second wiping blade is positioned relative to the first wiping blade to capture runoff of the one of solder paste and adhesive flowing from the first wiping blade as the squeegee device traverses the stencil surface in the first direction.

9. The apparatus of claim 7, wherein the first wiping blade is positioned relative to the second wiping blade to capture runoff of the one of solder paste and adhesive flowing laterally from the second wiping blade as the squeegee device traverses the stencil surface in a second direction, opposite to the first direction.

10. (canceled)

11. The apparatus of claim 10, wherein the squeegee device is coupled to the material dispenser.

12. The apparatus of claim 1, further comprising a controller, the controller operatively coupled to the squeegee device to control a position of and a direction in which the squeegee device traverses the stencil.

13. (canceled)

14. (canceled)

15. (canceled)

16. (canceled)

17. (canceled)

18. (canceled)

19. (canceled)

20. (canceled)

21. (canceled)

22. A method of printing one of solder paste and adhesive on a surface of an electronic substrate, the method comprising:
loading an electronic substrate into a printing apparatus;
supporting the substrate with a substrate support during dispensing;
aligning a stencil above a surface of the electronic substrate, the stencil having at least one aperture through which material is deposited onto the surface of the electronic substrate;
depositing one of solder Past and adhesive on the stencil;
positioning a first wiping blade of a squeegee device coupled to the printing apparatus at a rake angle, the squeegee device being configured to contact a surface of the stencil and to distribute the one of solder paste and adhesive deposited thereon across the stencil surface to the at least one aperture; and
traversing the squeegee device across the stencil surface in at least the first direction.

23. The method of claim 22, wherein the rake angle of the first wiping blade is an angle sufficient to cause the one of solder paste and adhesive to flow in a direction from a location at or near an end to an opposite end of the first wiping blade when the squeegee device traverses the stencil surface and pushes the one of solder paste and adhesive deposited thereon across the stencil surface.

24. The method of claim 22, further comprising positioning a second wiping blade of the squeegee device spaced from and disposed parallel to the first wiping blade at a rake angle.

25. The method of claim 24, wherein the rake angle of the second wiping blade is an angle sufficient to cause the one of solder paste and adhesive to flow in a direction from a location at or near an end to an opposite end of the second wiping blade when the squeegee device traverses the stencil surface and pushes the one of solder paste and adhesive deposited thereon across the stencil surface.

26. The method of claim 25, further comprising offsetting the second wiping blade relative to the first wiping blade such that the second wiping blade is positioned relative to the first wiping blade to capture runoff of the one of solder paste and adhesive flowing laterally from the first wiping blade as the squeegee device traverses the stencil surface in the first direction.

27. The method of claim 26, further comprising positioning the first wiping blade relative to the second wiping blade to capture runoff of the one of solder paste and adhesive flowing from the second wiping blade as the squeegee device traverses the stencil surface in a second direction, opposite to the first direction.

28. A method of printing one of solder paste and adhesive on a surface of an electronic substrate, the method comprising:
loading an electronic substrate into a printing apparatus;
aligning a stencil above a surface of the electronic substrate;
positioning first and second wiping blades of a squeegee device above a surface of the stencil at a rake angle;
depositing one of solder paste and adhesive on the stencil;
moving the squeegee device in first direction along a print axis across the surface of the stencil to distribute one of solder paste and adhesive in such a manner that excess one of solder paste and adhesive flows from one end of the first wiping blade; and
moving the squeegee device across the surface of the stencil in a second direction, opposite the first direction, in such a manner that the second blade captures the excess one of solder paste and adhesive generated by the first blade and distributes the excess one of solder paste and adhesive across the second blade.

29. The method of claim 28, wherein the second wiping blade, upon moving in the second direction, generates excess one of solder paste and adhesive from an end of the second wiping blade, and wherein the first wiping blade, upon moving in the first direction, captures the excess one of solder paste and adhesive generated by the second blade and distributes the excess one of solder paste and adhesive across the first blade.

30. An apparatus for printing material including one of solder paste and adhesive on a surface of an electronic substrate, the apparatus comprising:
a frame;
a substrate support, coupled to the frame, to support the electronic substrate;
a stencil coupled to the frame;
a material dispenser, coupled to the frame and Positioned above the stencil, to dispense material including one of solder paste and adhesive on the stencil;
a squeegee device having first and second wiping blades; and
mean for moving the squeegee device in a first direction along a print axis across a surface of the stencil to distribute material in such a manner that excess material flows from one end of the first blade, and for moving the squeegee device in a second direction, opposite the first direction, in such a manner that the second blade captures the excess material generated by the first blade and distributes the excess material across the second blade.

31. The apparatus of claim 30, wherein the second wiping blade, upon moving in the second direction, generates excess material from an end of the second wiping blade, and wherein the first wiping blade, upon moving in the first direction, captures the excess material generated by the second blade and distributes the excess material across the first blade.
